(19) United States
(12) Patent Application Publication
(10) Pub. No.: US 2007/0248788 A1
(43) Pub. Date: Oct. 25, 2007

(54) Replacement automotive carpets

(76) Inventors: Glenn E. Cheek, Ringgold, GA (US); Bryan C. Macon, Dalton, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/406,983

(22) Filed: Apr. 19, 2006

(51) Int. Cl. D03D 27/00; B32B 33/00

(52) U.S. Cl. 428/97; 428/95

(57) ABSTRACT

An automotive carpet having a surface formed from nylon yam having a denier of from about 3000 to about 5000 wherein the nylon yarn is formed from nylon fibers having a bright luster and a denier per filament that ranges from about 8 to about 10 is described.

### BACKGROUND OF THE INVENTION

1 Field of the Invention

The present invention relates to carpets that can be used in automobile interiors such as passenger compartments and trunks.

2. Description of the Related Art

Sales of vintage automobiles are rising with the volume and prices of vintage 1960's and 1970's automobiles reaching record levels. Muscle cars such as Corvettes, Camaros, Mustangs and the like are particularly popular and desirable. The market for replacement parts for vintage cars is sizable with segments of the market sometimes exceeding the sales of the original parts. For many owners of vintage automobiles accuracy and appearance are of the utmost importance. Thus, there is a need for vintage automobile parts and new replacement parts. If original, vintage parts are not available it is important that new replacement parts mimic the original parts in appearance and performance as much as possible.

Original automotive carpets for 1960s and 1970s American automobiles were made from a blend of fibers that included rayon fibers. These automotive carpets and the types of rayon carpet fibers that were used in the original automotive carpets are no longer available. Current available rayon fibers do not have the same quality, appearance and/or luster as rayon fibers that were originally used in automotive interior carpets. Improvements in other types of fibers, such as nylon and polyester fibers, have made nylon and polyester fibers more available. The lack of availability of rayon fibers that have the same specifications as the rayon fibers that were used to make the original automotive carpets of the 1960s and 1970s has made it difficult if not impossible to replicate the appearance of the carpets that were supplied in American automobiles in the 1960s and 1970s.

### BRIEF SUMMARY OF THE INVENTION

The present invention provides an automotive carpet having a surface that includes greater than about 85 weight percent of nylon fibers, wherein the surface is formed from nylon yarn having a denier of from about 3000 to about 5000 and the nylon yam is formed from nylon fibers having a bright luster and a denier per filament that ranges from about 8 to about 10. In certain embodiments, the surface may include greater than about 90 weight percent of nylon fibers. In other embodiments, the surface may include greater than about 95 weight percent of nylon fibers, grater than about 97 weight percent of nylon fibers, greater than about 98 weight percent of nylon fibers, and even greater than about 99 weight percent of nylon fibers. In desirable embodiment, the nylon fibers are bulked continuous nylon fibers. In certain embodiments, the nylon yarns are twisted from about 2 to about 6 turns per inch prior to tufting into the primary backing. In certain more desirable embodiments, the nylon yarns are twisted from about 4 to about 6 turns per inch and more desirably about 4 and one half turns per inch. The automotive carpet may include a primary backing having a basis weight in the range of from about 100 grams per square meter to about 340 grams per square meter. In certain embodiments, the primary backing is a jute woven backing, a polypropylene woven backing or a nonwoven backing. The automotive carpet may further include a back coating that is formed from polyethylene particles and has a basis weight of from about 11 ounces per square yard to about 14 ounces per square yard. The automotive carpet can be molded to a non-planar, three-dimensional carpet and may be shaped to conform to an automotive interior, for example a passenger compartment or a trunk.

In one particularly desirable group of embodiments the present invention provides a three-dimensional, automotive carpet having a surface consisting essentially of nylon yam having a denier of from about 3000 to about 5000 wherein the nylon yam is formed from nylon fibers having a bright luster and a denier per filament that ranges from about 8 to about 10 and the nylon yarn is twisted at a rate of from about 4 to about 5 turns per inch before being tufted into a backing. In certain more desirable embodiments, the nylon yam has a denier of from about 3500 to about 4500 and the nylon fibers are bulk continuous fibers that have a denier of about 9 denier per filament and are extruded from nylon 6,6.

In yet another desirable group of embodiments, the present invention provides a three-dimensional, automotive carpet that consisting essentially of: a jute woven primary backing having a basis weigh of from about 8 ounces per square yard to about 10 ounces per square yard; a tufted surface having a basis weight of from about 16 ounces per square yard to about 25 ounces per square yard and consisting essentially of nylon fibers wherein the nylon fibers are bulk continuous fibers that have a bright luster and a denier of from about 8 denier per filament to about 10 denier per filament and are extruded from nylon 6,6; and a secondary backing having a basis weight of from about 11 ounces per square yard to about 14 ounces per square yard formed from a polyolefin or a mixture of polyolefins.

### BRIEF DESCRIPTION OF THE DRAWINGS

A full and enabling disclosure of the present invention, including the best mode thereof is set forth in the detailed description which makes reference to the appended figures in which:

FIG. 1 is a perspective view of a three-dimensional, replacement automotive interior carpet; and

FIG. 2 is an enlarged, cross-sectional view of a portion of an exemplary carpet laminate of the present invention.

### DETAILED DESCRIPTION OF THE INVENTION

The drawings and detailed description provide a full and detailed written description of the invention, and of the manner and process of making and using it, so as to enable one skilled in the pertinent art to make and use it, as well as the best mode of carrying out the invention. The detailed description uses numerical and letter designations to refer to features in the drawings. Like or similar designations in the drawings and description have been used to refer to like or similar parts of the invention. The examples set forth in the drawings and detailed description are provided by way of explanation of the invention and are not meant as limitations of the invention. The present invention thus includes any modifications and variations of the following examples as come within the scope of the appended claims and their equivalents.

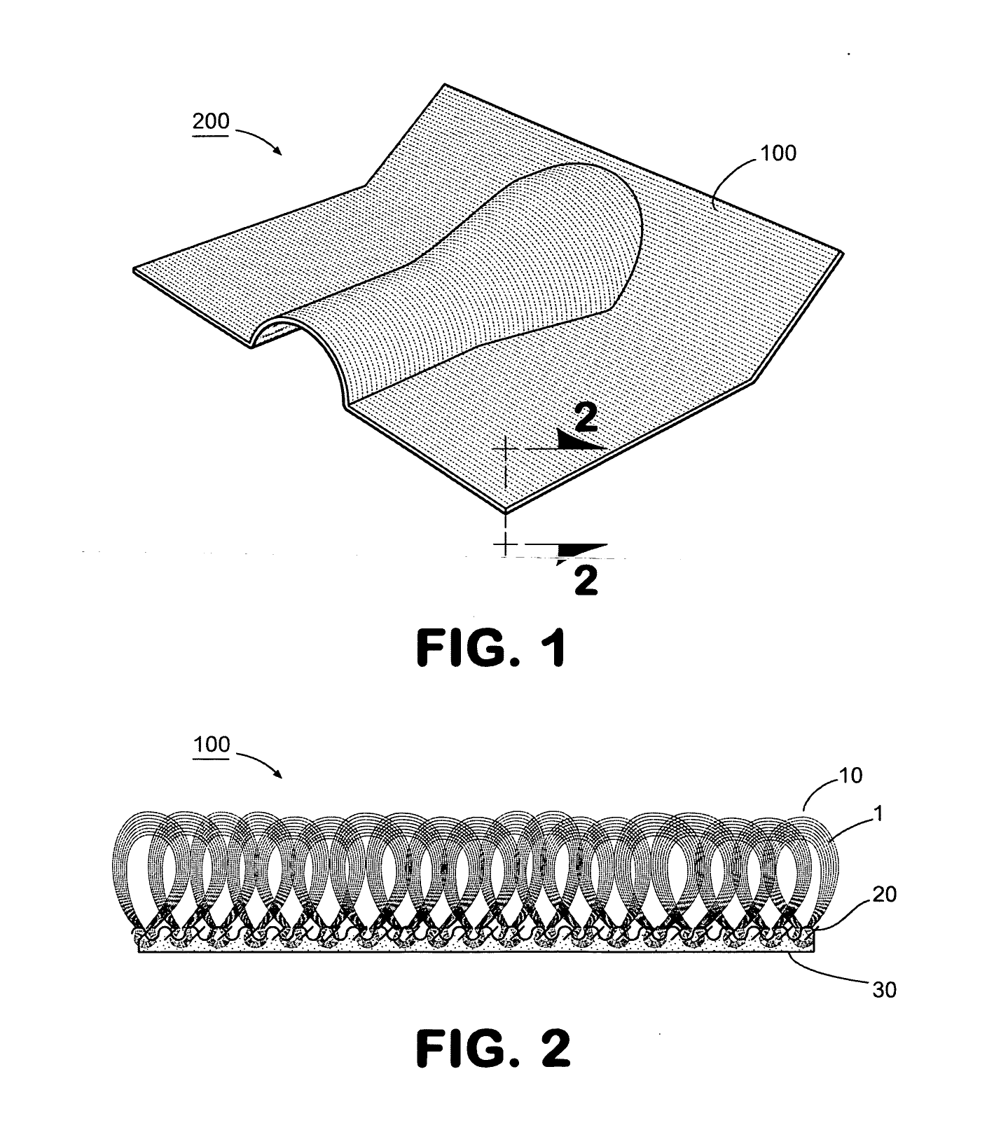

The present invention provides replacement carpets for automotive interiors that include a surface predominantly of nylon fibers or face yarns. In certain desirable embodiments, replacement carpet 100 can be molded to a non-planar, three dimensional configuration 200, an example of which is illustrated in FIG. 1. The non-planar, three dimensional configuration 200 can be shaped so as to conform to a particular automobile interior. Enlarged cross-sectional view through line 2-2 of the carpet 100 illustrates an exemplary composite carpet structure of the present invention. In desirable embodiments, bundles of fibers or yarns 1 that form the upper surface 10 of the carpet 100 are nylon fibers. Suggested nylons include, but are not limited to, nylon 6,6 and nylon 6 and include other melt-processable thermoplastic polyamides. Nylons may be characterized by having repeating amide groups. It is suggested that the nylon resin used to make the carpet fibers and face yarns has a melting point in the range of from about 175° C. to about 275° C. The nylon may be semicrystalline. Advantageously, nylon fibers have resistance to gasoline, grease, oil and other substances that may be tracked onto an automotive carpet surface.

Face yarns suitable as a component of the replacement automotive carpets according to the invented process may comprise a plurality of filaments. Preferably, the filaments comprise a polyamide thermoplastic resin; for example nylon 6,6 or nylon 6. In an exemplary embodiment, the yarn that forms the upper surface of the carpet is about 4000 in denier and is formed from bulked continuous fibers that are twisted to provide a desired look that closely matches carpet surfaces of 1960s and 1970s automobiles. Thus, in certain desirable embodiments, the face yarns are continuous filament yarns. And in more desirable embodiments, the continuous filament yarns used for carpet face yarn are bulked to provide texture resembling natural fiber yarns. Bulking is introduced by various techniques such as crimping, texturing with fluid jets, twisting and detwisting and so forth. Twisting, cabling, plying, heat setting and combinations of such techniques are often used to impart or preserve bulk in such yarns. Such bulked continuous filament yarns are commonly referred to as “BCF” yarns. In certain desirable embodiments, the yarn that is used to form the carpet surface is twisted in the range of from about 2 to about 6 turns per inch of yarn and more preferably is twisted from about 4 to about 5 turns per inch and still more preferably about 4 and one half turns per inch. Twisting of the yarns can be achieved on conventional equipment used for twisting yarns such as ring twisters and two for one twisters and so forth. The BCF yarns may be pigmented or solution dyed to provide a desired color. Pigmented yarns are prepared by incorporating pigments into the resin from which the filaments are melt spun. Generally, BCF face yarns have linear densities of at least about 1200. Deniers up to about 10,000 are possible and even deniers as high as 20,000 and even greater may be desirable in certain instances. In certain desirable embodiments, the yarn that is used to form the carpet surface has a denier from about 3000 to about 5000, more preferably from about 3500 to about 4500 and still more preferably the yarn has a denier of about 4000. Filament counts of typical face yarns range from about 70 to about 1200, with about 8 to about 30 denier per filament. In certain desirable embodiments, the BCF nylon fibers have high or bright luster. Fibers may have bright luster, semi-bright luster, semis-dull luster and dull luster depending on the finish desired.

The bundles of fibers or yarns 1 that form the carpet surface 10 are twisted and then tufted through a primary backing 20 as is know in the art. In the certain desirable embodiments, the fibers 1 are twisted a rate of about 4 and a half turns per inch and then tufted through the primary backing 20 to form a random loop pattern that closely matches the random look of the carpets that were typically supplied in American automobiles of the 1960s and 1970s. Suggested primary backing materials include, but are not limited to, jute woven backings and other woven and nonwoven backings and so forth. In certain desirable embodiments, the primary backing is or includes a jute woven backing or a woven polypropylene backing and in certain more desirable embodiments the primary backing is a woven jute backing having a basis weight of from about 8 to about 10 ounces per square yard. Suggested basis weights for nonwoven moldable primary backings range from about 100 grams per square meter (about 2.9 ounces per square yard) to about 120 grams per square meter (about 3.5 ounces per square yard).

The fibers or yarns 1 that make up the carpet surface are tufted into the primary backing 20. Latex or polyethylene 30 may be applied to the back surface of the primary backing to further secure the tufted fibers to the primary backing and/or improve the wearability of the carpet. In certain desirable embodiments, polyethylene particles are applied to the back surface and melted to secure the tufted fibers. Carpets that include polyolefin primary backings or backcoats are readily moldable to non-planar, three-dimensional automotive surfaces. An optional foam backing (not shown) may be laminated or otherwise added to the back surface enhance further enhance the acoustical and cushioning properties of the carpet and carpet laminates.

Advantageously, the surface of carpets of desirable embodiments of the present invention better match the carpet surfaces that were originally supplied on older automobiles than other carpets that are currently available. And, as previously stated, carpet laminates of certain desirable embodiments of the present invention can be hot molded permanently into non-planar, three-dimensional shapes so that the carpet can be conform to the contoured surfaces of a particular automobile model.

### EXAMPLE 1

A three-dimensional, automotive carpet surface was produced from Bulked Continuous Filaments (BCF) 4005 denier, nylon yarns that were obtained from INVISTA™ of Wichita, Kans. as follows. The BCF fibers that were obtained from INVISTA™ were sold under the trademark SUPRIVA® and the trade designation P1493. The SUPRIVA® P1493 yarn was formed from bulk continuous fibers made from nylon 6,6 that have a denier per filament of 9 and a bright luster finish. Earlier automotive loop carpets were traditionally made from a blend of spun fibers, specifically 80 percent of nylon spun fibers and 20 percent of rayon spun fibers. The yarn was twisted 4½ turns per inch before tufting. As previously stated, in certain embodiments carpets of the present invention do not use rayon fibers but are made from nylon fibers, preferably extruded nylon fibers and most preferably bulked continuous nylon fibers that have a denier per filament that ranges from about 8 to about 10 and that are twisted in to a yarn having a denier of from about 3000 to about 5000 that is then twisted from about 3 to about 5 turns per inch.

In this exemplary embodiment, the SUPRIVA® P1493 yam were twisted 4 and one half turns per inch and then tufted in to loop configurations on a ⅛ gauge loop tufting machine into a 9 ounce per square yard woven jute primary backing. The nylon fibers were tufted on the jute woven backing at a rate of about 20 ounces of fibers or yarns per square yard of backing. The amount of fibers per yard of backing may vary, for example from about 16 osy to about 25 osy. Polyethylene particles were then applied to the back surface of the primary backing at a rate of from about 11 to about 14 ounces per square yard. More specifically, a backing of polyethylene particles was applied to the surface of the primary backing opposite the nylon fiber tufts. The polyethylene particles were heated with an infrared lamp to allow the particles to coalesce and form a back coating or layer over the back surface of the primary backing further securing the tufted nylon fibers. This carpet laminate can then be molded to form a three-dimensional automotive replacement carpet using the methods known in the art.

### COMPARATIVE EXAMPLE A

Comparative Example A was a conventional, automotive interior replacement carpet that had a surface that consisted of a blend of 80 percent spun nylon fibers and 20 percent of spun rayon fibers. The nylon fibers and the rayon had a denier of 15 to 20 denier per filament. The 80/20 blend of nylon and rayon fibers were loop tufted on a ⅛ gauge loop tufting machine onto a 9 ounce per square yard woven jute primary backing. 11-14 ounces per square yard of polyethylene particles had been applied to the back surface of the primary backing and melted using infrared heat as in Example 1 above.

The carpet laminate of Comparative Example A can also be molded to form a three-dimensional, automotive carpet.

Samples of the carpet laminates of Example 1 and Comparative Example A were tested for resistance to wear abrasion using ASTM test method D3884-01, Abrasion Resistance of Textile Fabrics (Rotary Platform, Double-Head Method). The number of cycles that were required for the abrasive wheel to wear through the carpet surface fibers until the carpet backing, the jute primary backing, was observed and recorded. This is considered as failure of the carpet sample. In addition, the amount of weight loss of fibers at this point of failure was measured. The results of the cyclic abrasive wheel testing are presented as follows. After 1550 cycles at 1000 grams load, Example 1 did not fail, i.e. carpet backing was not visible after 1550 cycles, and only 5.1 weight percent of the face fiber from the sample was lost. Comparative Example A failed the wear test after 1550 cycles at 1000 grams and lost 21.4 weight percent. It was noted that the carpet of Example 1 was able to resist 750 cycles as was Comparative Example A.

The test data shows that the nylon carpet surface of Example 1 has superior surface resistance to wear abrasion than conventional automotive carpet surfaces formed from a blend of 80 weight percent of nylon fibers and 20 weight percent of rayon fibers. Improved wear resistance of the nylon carpet surface will reduce and may even eliminate pilling and fuzzing of carpet fibers at the carpet surface, thus, maintaining the appearance of the original carpet surface. Such wear resistance is highly desirable. More importantly, the nylon carpet surface more accurately replicates the look and feel of original equipment manufacturer's (OEM) automotive carpets that were provided in earlier automobiles compared to replacement automotive carpets that are currently available. In certain particularly desirable embodiments, carpet surfaces of the present inventions closely match the appearance of carpet surface of original 1960's and 1970's vintage automobiles. Although earlier automotive carpets were made from an 80/20 blend of nylon and rayon, the predominantly nylon carpet surfaces of the present invention better match the earlier 80/20 nylon/rayon carpet surfaces than current replacement automotive carpet surfaces. As previously stated, the rayon used in earlier 80/20 nylon/rayon carpet surface is different from the rayon fibers that are currently commercially available. Moreover, nylon carpet surfaces have improved light fastness properties compared to carpet surfaces formed from an 80/20 blend of nylon and rayon and resist fading further maintaining the appearance of the original carpet surface.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

We claim:

1. An automotive carpet having a surface comprising greater than about 85 weight percent of nylon fibers, wherein the surface is formed from nylon yarn having a denier of from about 3000 to about 5000 and the nylon yarn is formed from nylon fibers having a bright luster and a denier per filament that ranges from about 8 to about 10.

2. The automotive carpet of claim 1 wherein the surface comprises greater than about 90 weight percent of nylon fibers.

3. The automotive carpet of claim 1 wherein the surface comprises greater than about 95 weight percent of nylon fibers.

4. The automotive carpet of claim 1 wherein the surface comprises greater than about 97 weight percent of nylon fibers.

5. The automotive carpet of claim 1 wherein the surface comprises greater than about 98 weight percent of nylon fibers.

6. The automotive carpet of claim 1 wherein the surface comprises greater than about 99 weight percent of nylon fibers.

7. The automotive carpet of claim 1 wherein the nylon fibers are bulked continuous nylon fibers.

8. The automotive carpet of claim 1 wherein the nylon yarns are twisted from about 2 to about 6 turns per inch.

9. The automotive carpet of claim 1 wherein the nylon yarns are twisted from about 4 to about 6 turns per inch.

10. The automotive carpet of claim 1 further comprising a primary backing having a basis weight in the range of from about 100 grams per square meter to about 340 grams per square meter.

11. The automotive carpet of claim 10 wherein the nylon yarns are twisted from about 4 and one half turns per inch prior to tufting into the primary backing.

12. The automotive carpet of claim 10 wherein the primary backing is a jute or a polypropylene woven backing or a nonwoven backing.

13. The automotive carpet of claim 10 wherein the primary backing is a jute woven backing.

14. The automotive carpet of claim 13 wherein the automotive carpet further comprises a back coating that is formed from polyethylene particles and has a basis weight of from about 11 ounces per square yard to about 14 ounces per square yard.

15. The automotive carpet of claim 1 wherein the automotive carpet is a non-planar, three-dimensional carpet.

16. The automotive carpet of claim 1 wherein the automotive carpet hot molded into a non-planar, three-dimensional shape to conform to an automotive interior.

17. The automotive carpet of claim 15 wherein the automotive interior is a passenger compartment or a trunk.

18. A three-dimensional, automotive carpet having a surface consisting essentially of nylon yam having a denier of from about 3000 to about 5000 wherein the nylon yam is formed from nylon fibers having a bright luster and a denier per filament that ranges from about 8 to about 10 and the nylon yarn is twisted at a rate of from about 4 to about 5 turns per inch before being tufted into a backing.

19. The three-dimensional, automotive carpet of claim 18 wherein the nylon yarn has a denier of from about 3500 to about 4500 and the nylon fibers are bulk continuous fibers that have a denier of about 9 denier per filament and are extruded from nylon 6,6.

20. A three-dimensional, automotive carpet consisting essentially of:
a jute woven primary backing having a basis weigh of from about 8 ounces per square yard to about 10 ounces per square yard;
a tufted surface having a basis weight of from about 16 ounces per square yard to about 25 ounces per square yard and consisting essentially of nylon fibers wherein the nylon fibers are bulk continuous fibers that have a bright luster and a denier of from about 8 denier per filament to about 10 denier per filament and are extruded from nylon 6,6; and
a secondary backing having a basis weight of from about 11 ounces per square yard to about 14 ounces per square yard formed from a polyolefin or a mixture of polyolefins.
